(19) United States
(12) Patent Application Publication
(10) Pub. No.: US 2005/0145131 A1
(43) Pub. Date: Jul. 7, 2005

(54) Marking method and marked molding

(76) Inventors: Masaaki Takido, Fukushima (JP); Tadashi Abiko, Nihonmatsu-shi (JP); Toshihiko Umehara, Nihonmatsu-shi (JP)

Correspondence Address: JACOBSON HOLMAN PLLC, 400 SEVENTH STREET N.W., SUITE 600, WASHINGTON, DC, 20004, US

(21) Appl. No.: 10/502,098

(22) PCT Filed: Oct. 1, 2003
(86) PCT No.: PCT/JP03/12617

(30) Foreign Application Priority Data
Oct. 1, 2002 (JP) 2002-288230

(51) Int. Cl. B41C 1/00; B41M 1/00

(52) U.S. Cl. 101/483

(57) ABSTRACT

A method for readily applying a marking to an object made of PTFE, for example, a seal ring provided with a cut portion on a part of a circumference, or an intermediate product for the seal ring, comprising the steps of preparing an object to be marked that is made of PTFE, irradiating a laser beam onto the object to be marked to alter the state of only an irradiated surface of the PTFE, and forming a marking with a white-based color on the irradiated surface of the PTFE so that the irradiated surface exhibits a color tone different from that of a non-irradiated surface of the PTFE.

### BACKGROUND OF THE INVENTION

This invention relates to a marking method and a product marked by the marking method, and more particularly relates to a method for applying a marking to an object to be marked by irradiating a laser beam onto the object and a product obtained by the method. Also, the present invention is utilized when identification is required in a technical field for using or producing PTFE (polytetrafluoroethylene).

Heretofore, it has been required for a marking to be applied to a surface of a resin-molded product in order to identify the product by means of a type or a lot number of an article.

There are known conventional marking methods for a resin material, such as a method for forming a marking by irradiating a laser beam onto a thermoplastic resin material to make a foamed bulge (Japanese Patent Laid Open No. 62-13287); a method for forming a marking by irradiating a laser beam onto a surface of a transparent electrode substrate to melt the substrate surface (Japanese Patent Laid Open No. 9-175025); a method for forming a marking by coating a surface of an object with resin paint to make a resin film layer, and irradiating a laser beam onto the resin film layer to discolor it by means of thermal change without peeling the resin film layer (Japanese Patent Laid Open No. 4-42122); a method for forming a marking by irradiating a laser beam onto a resin composition containing an additive to discolor and foam the additive (Japanese Patent Laid Open No. 2001-113830); a method for forming a marking by irradiating a laser beam onto a plastic material containing carbon black or graphite as a filler to discolor the filler (Japanese Patent Publication No. 61-11771); a method for forming a marking by irradiating a laser beam onto a thermoplastic resin material containing borate to foam or resolve it (Japanese Patent Laid Open No. 8-142510); a method for forming a marking by irradiating a laser beam onto a thermoplastic resin material containing carbon black, iron oxide, ultraviolet absorbent, or the like as a filler (Japanese Patent Laid Open No. 2001-294758). However, since these methods are to form the marking by peeling a part of a coating film or by mixing a foaming agent or a discoloring agent into a resin material, the methods have a problem of causing foreign substances, a problem of increasing a man-hour, a problem of requiring a special compounding agent, or a problem of limiting a range of composition of a material which can be marked. In addition, these methods neither disclose nor suggest application of a marking on PTFE.

On the other hand, some conventional methods for applying a marking to PTFE employ a technique of paint coating or stamping. However, the marking method employing the technique of using paint has following problems.
(1) Since PTFE has repellency against water and oil on its surface due to its material characteristics, it has a poor wet property for paint and thus paint cannot be applied uniformly to PTFE. This results in an uneven or unclear marking.
(2) Since PTFE has a poor adhesive property on other materials, marking paint will be easily stripped from PTFE. The product thus cannot be identified and the stripped paint will cause foreign substances. Consequently, such marked product will not satisfy a requirement for an essential property of an article.
(3) In the case of coating PTFE with paint, since a paint layer increases partially a thickness of the PTFE, such marked product will not satisfy a requirement for an essential property of an article.
(4) It is required for a long period in time to dry a dispersion medium such as water or organic solvent used in paint.
(5) In the case where a marking surface is not flat (for example, a curved surface, or a polygonal surface), it is impossible to apply printing with paint on that surface.
(6) Although it is necessary to add a special additive for the purpose of marking, the additive is not necessary for a product in view of an essential property of the product. Accordingly, it is necessary to suitably select an additive to be used in accordance with an application and a function of a product or a finished article. This will require a lot of man-hours for steps of selection and addition. Moreover, as stated above, since the additive is not necessary for a product in view of an essential property of the product, the additive may cause contaminants.

Accordingly, an aim of the present invention is to provide a method for readily applying a marking to an object to be marked which is made of PTFE and to provide a product obtained by the method.

Still other aims and advantages of the invention will in part be obvious and will in part be apparent from the specification.

### SUMMARY OF THE INVENTION

To achieve the above aims, the present invention according to claim 1 is directed to a method for applying a marking to an object to be marked by irradiating a laser beam onto the object. The method comprises the steps of: preparing an object to be marked which is made of a material of PTFE; irradiating a laser beam onto the object to be marked to alter the state of only an irradiated surface of the PTFE; and forming a marking with a white-based color on the irradiated surface of the PTFE so that the irradiated surface exhibits a color tone different from that of a non-irradiated surface of the PTFE.

The invention of claim 2 is directed to a product marked by a method for applying a marking to an object to be marked by irradiating a laser beam onto the object, comprising the steps of: preparing an object to be marked which is made of a material of PTFE; irradiating a laser beam onto the object to be marked to alter the state of only an irradiated surface of the PTFE; and forming a marking with a white-based color on the irradiated surface of the PTFE so that the irradiated surface exhibits a color tone different from that of a non-irradiated surface of the PTFE.

The features of the present invention are as follows.
(1) It is possible in the present invention to apply a marking to PTFE that contains no filler. When the marking method of the present invention is applied to the PTFE, an irradiated portion of the PTFE is altered (to cause fluffing) while a non-irradiated portion of the PTFE is not altered (not to cause fluffing). Although both portions exhibit the same white colors, which are slightly short of identification, the irradiated portion can be distinguished from the non-irradiated portion on account of different degrees of reflection in light between them.
(2) It is possible in the present invention to apply a marking to PTFE that contains any filler.
   a) In the case where a filler has a color other than a white-based color:

If the marking method of the present invention is applied to PTFE that contains a filler which has a color other than a white-based color, a marking is excellent at identification, since the irradiated portion of the PTFE is altered (to be fluffed) while exhibiting its own white color and exhibits a distinct contrast.
b) In the case where a filler has a white-based color:

The marking method of the present invention can be applied to a filler that has a white-based color. If the marking method of the present invention is applied to PTFE that contains a filler which has a white-based color, a difference between the irradiated portion and the non-irradiated portion is present on account of different degrees of reflection in light, although the irradiated portion is slightly poor in identification.

It is preferable to select a filler from materials such as glass fiber, carbon fiber, glass bead, carbon powder, potassium titanate fiber, alumina powder, bronze powder, silica powder, boron nitride powder, molybdenum disulfide powder, silicon nitride powder, aromatic polyester powder, polyetheretherketone powder, polyimide powder. It should be noted that the filler is not limited to the above materials.

In the case where an object to be marked is made of PTFE, when the object is irradiated by a laser beam, PTFE is fluffed and a surface of the object is covered with PTFE to exhibit its own white-based color. Thus the function of a marking is achieved. It is preferable to set an amount of PTFE that covers the surface of the object in accordance with a hue of a base material (a hue of an object to be marked) to identify the marking.

The marking method of the present invention does not employ a conventional technique of peeling a paint material, peeling a surface layer, discoloring or color-developing a composition such as a special filler, or foaming a blowing agent but employs marking with a white-based color by means of fluffing. PTFE can be selected in accordance with fluffing regardless of a kind and an amount of a filler. Accordingly, it is possible to select a mixture of PTFE and other resin material or elastomer within a range of composition that the PTFE is fluffed. Also, the marking method of the present invention is advantageous, since no foreign substances are caused during irradiation of a laser beam.

Principles in conventional marking methods are explained by the following three patterns in FIGS. 3A, 3B and 3C.
(1) Peeling of a printed surface (a contrast between an upper layer 52 and a lower layer 53 is present by peeling an ink or a paint 51 on the upper surface 52 (see FIG. 3A).
(2) Peeling of a surface layer (a surface layer 54 is peeled by a laser beam (see FIG. 3B).
(3) Color development due to chemical change (a surface 55 is brought into color development by causing a chemical change by means of irradiation of a laser beam (see FIG. 3C).

It should be noted that the present invention is not based on any of the above principles. The present application includes the following embodiments.
(1) A marking with a white-based color on PTFE by utilizing a laser apparatus.
(2) A product marked by irradiating a laser beam onto PTFE.
(3) A method for applying a marking to PTFE by irradiating a laser beam.
(4) A marking with a white-based color on PTFE that contains a filler by utilizing a laser apparatus.
(5) A product marked by irradiating a laser beam onto PTFE that contains a filler.
(6) A method for applying a marking to PTFE that contains a filler by irradiating a laser beam.
(7) A method for applying a marking to an object to be marked by irradiating a laser beam onto the object, comprising the steps of: preparing an object to be marked which is made of a material of PTFE; irradiating a laser beam onto the object to be marked to alter the state of only an irradiated surface of the PTFE; and forming a marking with a white-based color on the irradiated surface of the PTFE so that the irradiated surface exhibits a color tone different from that of a non-irradiated surface of the PTFE.
(8) A product marked by a method for applying a marking to an object to be marked by irradiating a laser beam onto the object, comprising the steps of: preparing an object to be marked which is made of a material of PTFE; irradiating a laser beam onto the object to be marked to alter the state of only an irradiated surface of the PTFE; and forming a marking with a white-based color on the irradiated surface of the PTFE so that the irradiated surface exhibits a color tone different from that of a non-irradiated surface of the PTFE.

### BRIEF DESCRIPTION OF THE DRAWINGS

The features of the present invention believed to be novel and the elements characteristic of the present invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is an enlarged photographical view of a surface of a PTFE composition, which is marked by a marking method according to an embodiment of the present invention;

FIG. 2 is a perspective view of a seal ring, which is marked by a marking method according to an embodiment of the present invention; and

FIGS. 3A, 3B, and 3C are explanatory views, each illustrating a principle of a conventional laser marking method.

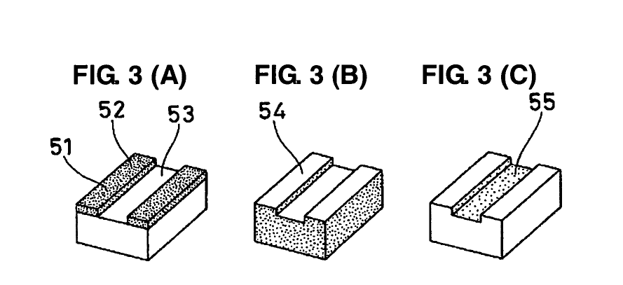

### DETAILED DESCRIPTION OF THE PREFERRED EMBODIMENTS

Referring to the drawings, embodiments of the present invention will be now explained below.

A laser beam source to be used in a marking method of the present invention may be, for example, a gas laser such as a CO₂ laser, a semiconductor laser, a solid body laser such as a YAG laser, or the like. An amount of a thermal irradiation for marking depends on a degree of identification, although there are some differences among kinds of laser. The present invention will be described below in more detail in connection with a condition of irradiation using a CO₂ laser.

A PTFE product, which is used as an object to be marked, is a sheet (20 mm×20 mm×2 mm) obtained by pressing and baking a mixture in which 17 parts by weight of carbon fiber having a length of 100 μm are dispersed in 100 parts by weight of PTFE. The sheet has a black-based color.

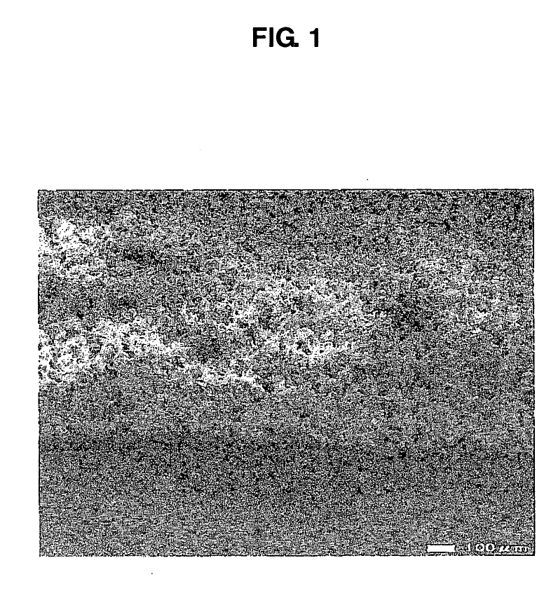

FIG. 1 shows an electron micrograph of a marking applied under a condition of 3.6 W in power and 300 mm/s in marking speed. In FIG. 1, an upper layer shows a portion irradiated by a laser beam while a lower layer shows a non-irradiated portion. The words “to alter PTFE by irradiating a laser beam (to cause fluffing)” described herein means the state of the upper layer shown in FIG. 1.

Next, conditions and results in examples of a marking according to the embodiment are shown in Table 1.

As shown in Table 1, when a marking speed is fixed at 150 (mm/s), a marking exhibits a distinct white-based color at 1.2 W or more of power.

Further, when a marking speed is fixed at 300 (mm/s), a marking exhibits a distinguishable white-based color with fluffing at about 2 W of power and exhibits a distinct white-based color at 3.6 W or more of power.

Still further, when a marking speed is fixed at 400 (mm/s), a marking exhibits a distinguishable white-based color with fluffing at about 2 W of power and exhibits a distinct white-based color at 4.8 W or more of power.

However, since an irradiated portion is subject to change in surface roughness and thickness in comparison with a non-irradiated portion, a surface state of the irradiated portion may exert an influence upon a function of an article. For example, when a CO₂ laser, in which a diameter of a laser beam is 14 mm, is used to apply a marking to a seal ring, the seal ring is subject to the following effects.
(1) Deformation, for example, deterioration of circularity, change of thickness;
(2) Concave and undulation of surface
(3) Deterioration of physical properties in a surface layer (mechanical strength, elongation, energy of rupture, abrasion resistance and the like)
(4) Abnormality in frictional phenomenon upon sliding.

The above effects may cause a possibility of deterioration of a leak-proof performance. Accordingly, even if a marking is in a distinguishable state, it may be not suitable to an article.

In view of the above evaluation on Table 1, it will be preferable to apply a marking to an object to be marked by increasing a power of laser and a marking speed in order to obtain an excellent marking without affecting a primary function of an article.

Accordingly, it will be preferable from Table 1 that a marking condition in the present embodiment is 1.2 W of power at 150 mm/s of a marking speed, 3.6 to 6 W of power at 300 mm/s of a marking speed, and 4.8 to 8.4 W of power at 400 mm/s of a marking speed.

It is possible to control a marking state (contrast) by regulating a power of an irradiating laser beam and a marking speed. That is, if the power is lowered and the marking speed is increased, the marking state (contrast) is attenuated while if the power is raised and the marking speed is decreased, the marking state (contrast) is deepened.

In the case of applying a laser beam to an object to be marked which is made of PTFE, a surface temperature on the object upon irradiation of the laser beam will be estimated by the following equation:
Tₚ=2βF/(√(πλcp))×√(t)
Tₚ: surface temperature (° C.)
β: absorption factor of laser
F: power density (W/cm²)
λ: coefficient of thermal conductivity (cal/cm ° C. s)
c: specific heat (cal/° C. g)
p: density (g/cm³)
t: irradiating period in time (s)

A product, which is made of PTFE, may be, for example, a seal ring, a backup ring, a thrust washer, a slipper seal, a wear ring, a bellows, or a sheet. It should be noted that the above products are not limited. A marking method of the present invention can be applied to an intermediate product or an end product of each of the above products. For example, an intermediate product for the seal ring is a product before being cut while an end product for the seal ring is a product after being cut.

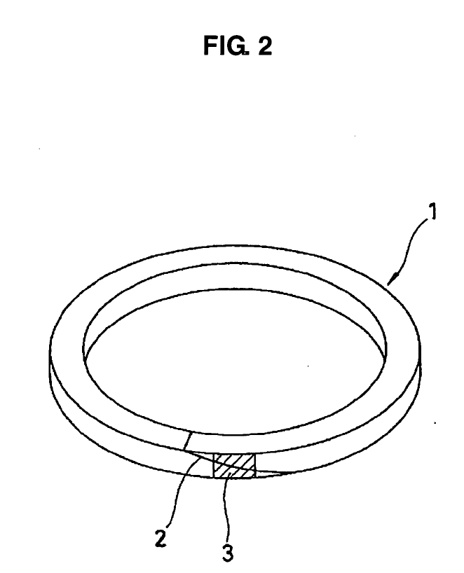

In a seal ring 1 that is provided with a cut portion 2, as shown in FIG. 2, it is possible to identify the cut portion 2 by applying a marking 3 with a white-based color to the cut portion 2 before hand. Such marking 3 can be used to position the cut portion 2. The cut portion 2 is utilized as a fitting part when assembling. The cut portion 2 is formed into a straight cut or a stepped cut as well as a bias cut shown in FIG. 2.

In the case where the seal ring 1 is made of PTFE including a filler in a dark color, when an outer peripheral position on the cut portion 2 is irradiated by a laser beam in accordance with the marking method of the present invention, a PTFE portion is fluffed, as shown in FIG. 1, thereby applying to the cut portion 2 the marking 3 that has a primary white-based color of PTFE.

Accordingly, it is possible in the seal ring to easily identify the cut portion 2 that serves as a fitting part, to identify similar seal rings, or to identify orientation of the seal ring. Also, in the case of applying a marking with a white-based color to an intermediate product for the seal ring 1, a marking work can be done simultaneously to a plurality of them.

Although the marking 3 is depicted in a simple band-like pattern in FIG. 2, various kinds of characters, signs, figures or the like such as a name of a company, an article code, or the like can be marked.

The irradiated and fluffed portion with a white base color is returned to the original color by means of friction, because a fluffed state of the PTFE is returned to the original dense state color. Accordingly, when a marking is applied to a sliding portion, the marking serves as a signal on a product but the marking is abraded away by the above reaction after the product is transformed into a finished article and the finished article is assembled in a sliding portion. In other words, the marking will be good enough to remain effective (not to be abraded away) from a producing step to a assembling step. Even if the marking is worn after assembling, this will not affect a primary function of the finished article. If a marking is applied to a non-sliding portion of a product, various kinds of characters, signs, figures or the like such as a name of a company, an article code, or the like can be applied to the portion. If the marking is applied to a non-sliding portion of a product, since the marking is not abraded away, it is possible to identify a finished article and not to affect a function of the article.

The present invention has the following advantages.

In a marking method according to claim 1 and a product according to claim 2, it is possible to readily apply a marking with a white-based color to an object to be marked, which is made of PTFE. Accordingly, when it is necessary to identify a product made of PTFE, it is possible to easily perform an identifying work.

According to the marking method of the present invention, it is possible to directly apply a marking to a product without working a surface of PTFE that is an object to be marked. Consequently, it is possible to form a uniform and distinct marking.

According to the marking method of the present invention, since the marked portion is not peeled and foreign substances due to peeling are not caused, the marking does not affect a primary function of the marked product.

Accordingly, a marking of the present invention can be applied to a sliding portion of a product.

Since it is not necessary to dry a marked portion in the present invention, a period in time required for marking can be shortened.

In the present invention, when an object to be marked is irradiated by a laser beam, since an irradiated portion of PTFE is altered (fluffed) and the portion of the object exhibits a white-based color that is a primary color of PTFE, thereby the function of a marking being achieved, it is possible to apply a marking to any surface on the object that is not flat.

In the marking method of the present invention, since it is not required to add a special additive for the purpose of marking, which is unnecessary for a primary function of a product or a finished article, it is possible to omit a work of selecting an additive for every objects to be marked or adding an additive to the object. Also, it is possible to avoid generation of contaminants from a product or a finished article.

The present invention can further obtain the following effects.
(1) It is possible to easily control a contrast with a white-based color by regulating a power and an irradiating speed of a laser apparatus.
(2) It is possible to apply a marking with small characters to an object to be marked, since it is possible to readily carry out a control of a marking size.
(3) In comparison with a conventional technique, the present invention is not subject to limitation of peeling of paint, peeling of a surface layer, discolor or color development of a composition such as a special filler or the like, and mixing of a special forming agent, PTFE is not subject to limitation of composition.

While the present invention has been particularly described, in conjunction with a specific preferred embodiment, it is evident that many alternatives, modifications, and variations will be apparent to those skilled in the art in light of the foregoing description. It is therefore contemplated that the appended claims will embrace any such alternatives, modifications, and variations as falling within the true scope and spirit of the present invention.

1. A method for applying a marking to an object to be marked by irradiating a laser beam onto said object, comprising the steps of:
preparing an object to be marked that is made of a material of PTFE;
irradiating a laser beam onto said object to be marked to alter the state of only an irradiated surface of the PTFE; and
forming a marking with a white-based color on the irradiated surface of the PTFE so that the irradiated surface exhibits a color tone different from that of a non-irradiated surface of the PTFE.

2. A product marked by a method for applying a marking to an object to be marked by irradiating a laser beam onto said object, comprising the steps of:
preparing an object to be marked that is made of a material of PTFE;
irradiating a laser beam onto said object to be marked to alter the state of only an irradiated surface of the PTFE; and
forming a marking with a white-based color on the irradiated surface of the PTFE so that the irradiated surface exhibits a color tone different from that of a non-irradiated surface of the PTFE.
